(19) United States
(12) Patent Application Publication
(10) Pub. No.: US 2011/0269593 A1
(43) Pub. Date: Nov. 3, 2011

(54) Electro-Hydraulic Differential Lock

(76) Inventors: Richard N. Knowles, Waterloo, IA (US); Brian D. Durbin, Waverly, IA (US); Chad Vandenberg, Dike, IA (US); Duane F. Meyer, Hudson, IA (US)

(21) Appl. No.: 13/003,038

(22) PCT Filed: Jul. 7, 2008
(86) PCT No.: PCT/US08/08308

§ 371 Date: Mar. 8, 2011

(51) Int. Cl. F16H 48/20

(52) U.S. Cl. 475/84

(57) ABSTRACT

A differential locking device (10) includes a differential (12) having a differential housing (13) coaxial with a pair of axle shafts (30,32). The differential housing (13) includes a pair of side gears (26, 28) splined to the pair of axle shafts (30, 32) and a plurality of pinion gears (22) which engage the side gears (26,28). A locking collar (44) splined to one of the axle shafts (30) is sildable between an unlocked position and a locked position. A hydraulic piston (54) applies pressure to the locking collar (44) to actuate the locking collar (44) to the locked position, wherein teeth (46) on the locking collar (44) engage corresponding teeth (50) on the differential housing (14) thereby fixing the differential housing (14) for rotation with the locking collar (44) and thus the side gears (26,28). The resulting differential locking device is compact and can be engaged or disengaged quickly.

### BACKGROUND

1. Field of the Invention

The invention generally relates to differential locks for vehicle differentials. Specifically, the invention relates to the mechanism for activating the differential lock.

2. Description of Related Technology

A differential typically is provided in a vehicle to allow speed differences between driven wheels on either side of the vehicle during cornering. One problem with using a differential for this purpose is that if one of the wheels connected to the differential loses traction, drive to both wheels fails. Accordingly, the differentials of vehicles which are likely to lose traction on one of their wheels, e.g., off-road vehicles, typically are provided with a differential lock to selectively prevent relative rotation of the parts of the differential.

While there are many types of differential locks, one of the more common is a hydraulically actuated clutch which, when activated, prevents relative rotation between the housing of the differential and one of the side gears of the differential. Typical clutches include a number of separator plates and clutch disks. Further, such clutches normally are activated by a hydraulic piston that rotates with the differential. The disadvantage to this structure is that rotating seals are required somewhere in the hydraulic system providing oil to move the piston. Such rotating seals almost always inherently leak and they generally have a pressure limit (about 2700-4100 kPa) much lower than that required of may off-road and work vehicles, e.g., tractors, bulldozers and the like, which have a typical system pressure of about 15,500 kPa. This means that a pressure-reducing valve must be provided to supply hydraulic fluid to operate the differential lock.

In view of the above, it is apparent that there exists a need for a more efficient, low cost, and compact differential locking device.

### SUMMARY

One objective of the present invention is to provide an economical and compact differential locking device for locking the differential output of a vehicle to be equal to left and right axle shafts. Such a differential locking device includes a differential rotatably mounted within a differential case. The differential includes a differential housing coaxial with left and right axle shafts which extend through the differential housing and are rotatable about a rotational axis. Disposed within the differential housing is a pair of side gears. Each of the side gears is spline to the first and second axle shafts. A plurality of pinion gears engages the pair of side gears. A locking collar is splined to one of the axle shafts and is slidable along the axle shaft between an unlocked position and a locked position. In the unlocked position, the locking collar is out of engagement with the differential housing. In the locked position, the locking collar engages the differential housing and thereby fixes the differential housing for rotation with the locking collar. A hydraulic piston actuates the locking collar into the locked position by applying a pressure to the locking collar along the rotational axis.

In one embodiment, the locking collar and the side gears are similarly spliced to the axle shafts. Therefore, when the locking collar engages the differential housing and fixes the differential housing for rotation with the locking collar, the locking collar thus fixes the differential housing for rotation with the side gears, providing equal output to both axe shafts.

In another embodiment, a hydraulic chamber formed between the piston and the differential housing receives a hydraulic fluid from a pressurized fluid source via a hydraulic fluid passage formed within the differential casing 13. This fluid drives the piston to actuate the locking collar into the locked position.

In yet another embodiment, a biasing spring is disposed coaxially about one of the axle shafts between one of the side gears and the looking collar. The biasing spring biases the locking collar to the unlocked position, away from the differential housing. During operation, the hydraulic fluid presses the piston in a first direction, which actuates the locking collar to compress the spring and the locking collar moves into the locked position. When the hydraulic fluid pressure is released from the piston, the biasing spring returns the locking collar to the unlocked position and thereby moves the piston in a second direction.

In yet another embodiment, the locking collar includes a plurality of teeth for engaging a corresponding plurality of teeth of the differential housing when the locking collar is in the locked position.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is an exploded partial perspective view of a differential locking device in accordance with an embodiment of the present invention;

FIG. 2a is a cross-sectional view of the differential locking device taken generally along axis A of FIG. 1 illustrating the differential locking device in the disengaged position;

FIG. 2b is partial side view of the differential locking device of FIG. 2a;

FIG. 3a is a cross-sectional view of the differential locking device taken generally along axis A of FIG. 1 illustrating the differential locking device in the engaged position; and

FIG. 3b is a partial side view of the differential locking device of FIG. 3a.

### DETAILED DESCRIPTION

The following description is merely exemplary in nature and is in no way intended to limit the present invention or its application or uses. It should be understood that throughout the description and drawings, corresponding reference numerals indicate like or corresponding parts and features.

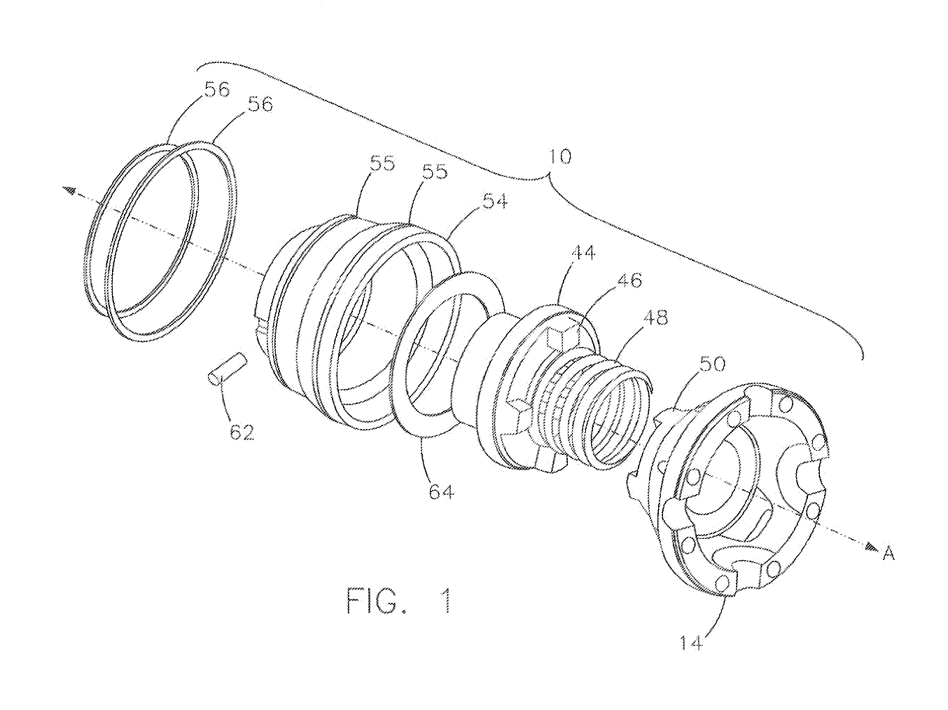

Referring to the drawings, FIGS. 1-3b illustrate a portion of a differential locking device 10 in accordance with the present invention. The differential locking device 10 includes a differential 12 rotatably mounted within a differential casino 13 in a known manner. A ring gear 18 delivers torque input to the differential 12, thus driving the differential 12, which in turn drives a pair of axle shafts 30 and 32 extending through the differential housing 14 of the differential 12. The axle shafts 30 and 32 are in turn drivingly coupled with vehicle wheels (not shown). The ring gear is mounted to a flange 15 of the differential housing 14 by any suitable means, such as a plurality of bolts 20, such that differential housing 14 and the ring gear 18 rotate together.

The differential housing defines a gear chamber 16. Disposed within the gear chamber 16 is a differential gear set including a plurality of input pinion gears 22 which are rotatably mounted on an input pinion shaft 24. Typically, the pinion shaft 24 is secured relative to the differential housing 12 by some suitable means, such as a locking pin. The pinion gears 22 comprise he input gears of the differential gear set, and are in meshing engagement with a pair of side gears 26 and 28 which comprise the output gears of the differential gear set. The side gears 26 and 28 are splined to, and therefore rotatable with, the axle shafts 30 and 32, respectively. A pair of thrust bearings 33 and 35 is provided between the differential housing 12 and the side gears 26 and 28, respectively, to allow relative rotation therebetween. The differential housing 12 includes annular hub portions 34 and 36, on which may be mounted a pair of bearing sets 38 and 40 used to provide rotational support for the differential housing 12 relative to the differential casing 14. The bearings 38 and 40 are preferably ball bearings which do not require preload, and therefore are left unconstrained axially. Hence, there is only one side quill 42 which is adjacent the hearing 40 as opposed to two side quills typically used to support tapered roller bearings.

Power is transferred from the pinion gears 22 to the differential housing 14 to the axle shafts 30 and 32 via the side gears 26 and 28. The side gears 26 and 28 are in constant mesh with the pinion gears 22. When the vehicle is driven in a straight path, the ring gear 18, the differential housing 14, and the pinion gears 22 all rotate as one unit to transfer power to the axle shafts 30 and 32 via the side gears 26 and 28. There is no relative movement between the pinion gears 22 and the side gears 26 and 28 and thus no differentiation occurs between the left and right axle shafts 30 and 32

Under certain operating conditions, such as when the vehicle is turning, or there is a slight difference in the tire size, a certain amount of differentiating action may occur between the side gears 26 and 28. Above a predetermined differential between the speeds of the side gears 26 and 28, it is desirable to prevent the relative rotation between the differential housing 14 and the side gears 26 and 28, in order to prevent excessive differentiating action. There may also be operating conditions when it is desirable to lock up the differential 12, to prevent any differentiating action.

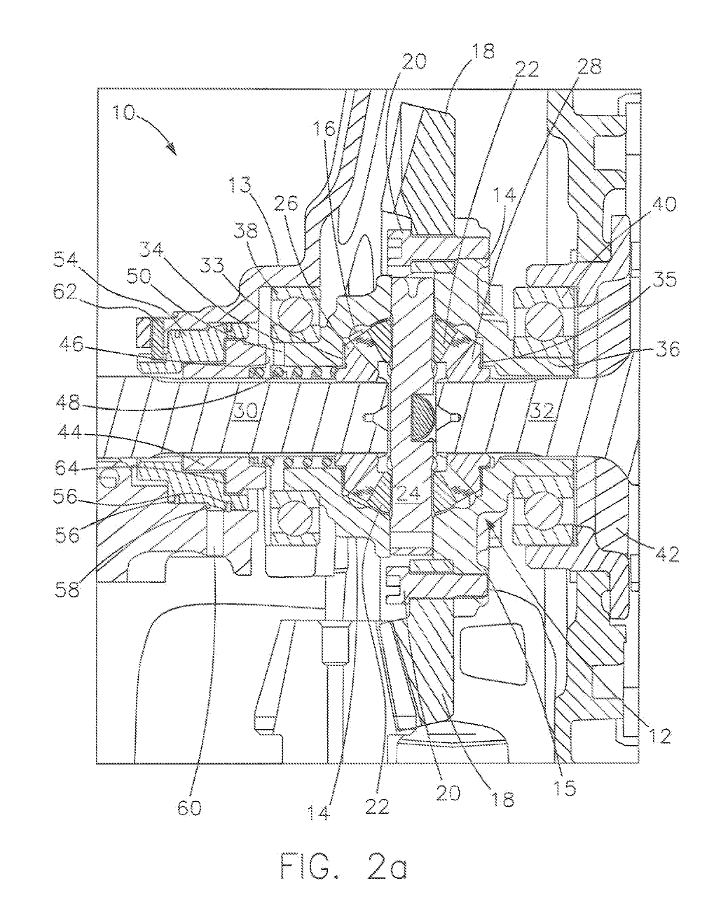

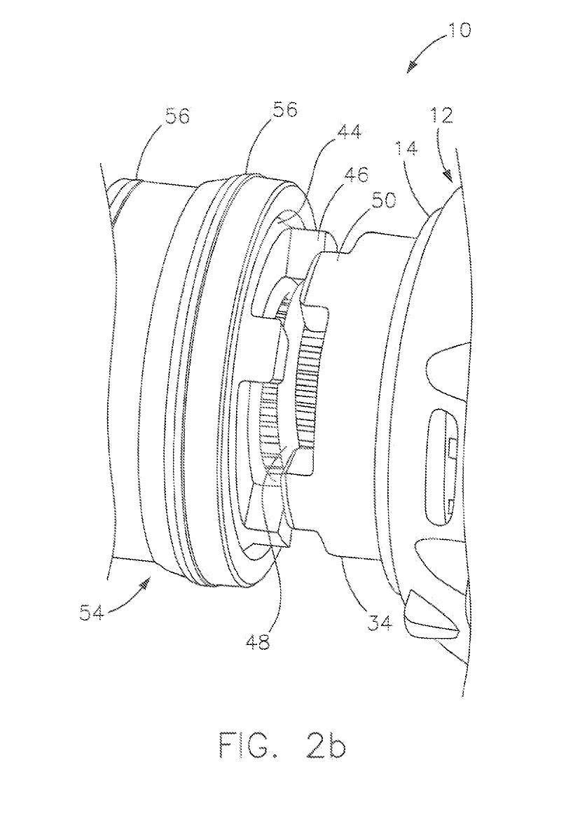

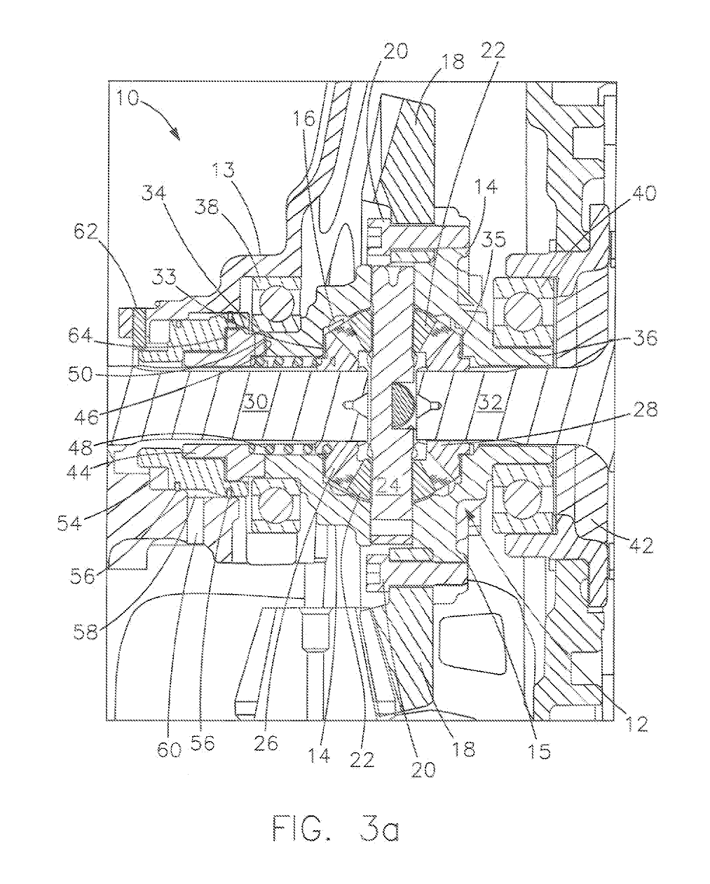

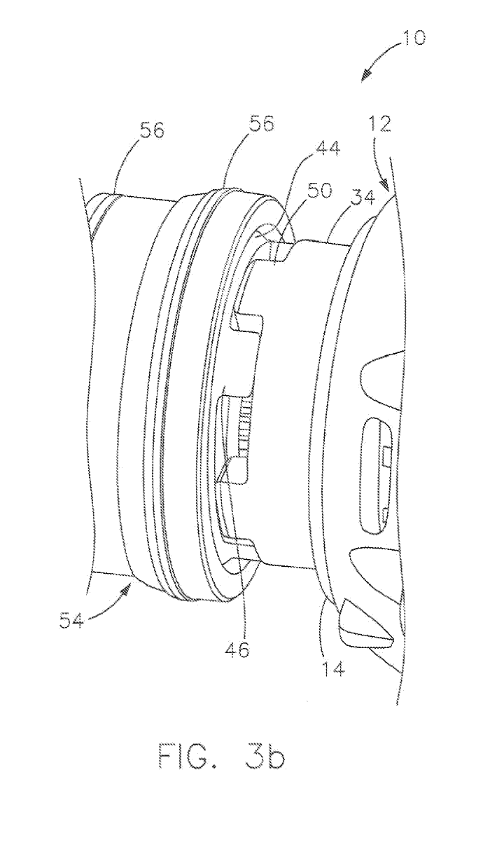

In order to prevent differentiating action, the differential locking device 10 is provided with an annular locking collar 44 splined to, and therefore rotatable with, the axle shaft 30. Thus, the locking collar 44 is fixed for rotation with the side gear 26, which is similarly splined to the axle shaft 30. Unlike a clutch pack including a number of separator plates and clutch disks, the locking collar 44 includes a simpler, more compact design comprising fewer parts. Preferably, the locking collar 44 is a dog clutch having at least one or more teeth 46. The locking collar 44 is slidable along the axle shaft 30 between an unlocked position (shown in FIGS. 2a and 2b) in which it is out of engagement with the differential housing 14, and a locked position (shown in FIGS. 3a and 3b) in which it engages the differential housing 14, locking out the differential 12 and causing the axle shafts 30 and 32 to rotate at the same speed. A spring 46 biases the locking collar 44 away from the differential housing 14. The spring 46 is a coil compression spring disposed coaxially about the axle shaft 30 between the locking collar 44 and the side gear 26.

The differential locking device 10 is further provided with a non-rotating piston 54 for actuating the locking collar 44. The piston 54 is preferably annular to distribute actuating pressure evenly around the annular locking collar 44. The piston 54 is disposed about the axle shaft 30 and includes non-rotating seals 56 extending between the piston 54 and the differential casing 13 to form a hydraulic chamber 58 therebetween. Hydraulic fluid can be provided to this chamber is a supply passage 60 connected to a source of pressurized fluid (not shown). A dowel or anti-rotation pin 62 is provided and prevents the piston 54 from spinning within the differential casing 13. A thrust bearing 64 is provided between the piston 54 and the locking collar 44 to transmit pressure from the piston 54 to the locking collar 44 while allowing relative rotation therebetween. The thrust bearing 64 preferably is in the form of a needle bearing, thrust washer, or any other suitable bearing.

In operation, when it is necessary to activate the differential locking device 10, hydraulic fluid is provided to the chamber 58 via the passage 60. The hydraulic fluid presses the piston 60 in a first direction (to the right in FIG. 2a), pressing the locking collar 44, via the thrust bearing 64, in the first direction. This pressure causes the locking collar 44 to slide along the axle shaft 30 into the locked position, compressing the spring 48 and engaging the differential housing 14. The locking collar teeth 46 engage the differential housing teeth 50, which in turn locks the differential housing 14 for rotation with the locking collar 44. Since the locking collar 44 is splined to the axle shaft 30, the engagement of the locking collar 44 with the differential housing 14 effectively locks the differential housing 14 to the axle shafts 30 and 32 and thereby fixes the differential housing 14 for rotation with the side gears 26 and 28.

Upon release of the pressure in the chamber 58, the teeth 46 and 50 disengage and the differential housing 14 is unlocks from the axle shafts 30 and 32. The biased spring 48 returns the locking collar 44 back into the unlocked position, again allowing relative rotation of the differential housing 14 and the side gears 26 and 28.

In accordance with the provisions of the patent statutes, the present invention has been described in what is considered to represent its preferred embodiment. However, it should be noted that the invention can be practiced otherwise than as specifically illustrated and described.

What is claimed is:

1. A differential locking device comprising:
a differential case;
a differential housing rotatably mounted within the differential case and coaxial with first and second axle shafts extending through the differential housing rotatable about a rotational axis;
a first and a second side gear disposed within the differential housing, the first and second side gears splined to the first and second axle shafts, respectively;
a plurality of pinion gears engaging the first and second side gears;
a locking collar splined to the first axle shaft slidable between a first position, herein the locking collar is disengaged from the differential housing, and a second position, wherein the locking collar engages the differential housing and thereby fixes the differential housing for rotation with the locking collar; and
a hydraulic piston which selectively actuates the locking collar into the second position by applying a pressure along the rotational axis.

2. The differential locking device of claim 1 further comprising a thrust bearing disposed between the piston and the locking collar, wherein the piston applies pressure directly to the thrust bearing and the thrust bearing applies pressure directly to the locking collar.

3. The differential locking device of claim 1 turner comprising a hydraulic chamber for receiving a hydraulic fluid from a pressurized fluid source via a hydraulic fluid passage, wherein the hydraulic chamber is formed between the piston and the differential housing, and wherein the hydraulic fluid drives the piston.

4. The differential locking device of claim 3 wherein the piston is an annular piston including a pair of circumferential grooves formed in an outer surface of the piston, wherein the pair of grooves receives a pair of seals, the seals extending between the outer surface of the piston and the differential casing, the hydraulic chamber being defined between the piston, the differential casing, and the seals.

5. The differential locking device of claim 3 wherein the hydraulic fluid within the hydraulic chamber provides a pressure which presses the piston and thereby actuates the locking collar to the second position.

6. The differential locking device of claim 5 further comprising a biasing spring which biases the locking collar to the first position, away from the differential housing, wherein the hydraulic fluid presses the piston in a first direction and actuates the locking collar to compress the spring and thereby move to the second position, wherein the hydraulic fluid pressure is released from the piston and the biasing spring returns the locking collar to the first position and thereby moves the piston in a second direction.

7. The differential locking device of claim 1 further comprising a biasing spring which biases the locking collar to the first position, away from the differential housing.

8. The differential locking device of claim 7 wherein the spring is a compression spring disposed coaxially about the first axle shaft between the first side gear and the locking collar.

9. The differential locking device of claim 1 wherein the locking collar includes a plurality of teeth for engaging a corresponding plurality of teeth of the differential housing when the locking collar is in the second position.

10. The differential locking device of claim 1 wherein the locking collar and the first side gear are splined to the first axle shaft and the second side gear is splined to the second axle shaft such that when the locking collar engages the differential housing and fixes the differential housing for rotation with the locking collar, the differential housing is thereby fixed for rotation with the first and second side gears.

11. The differential locking device of claim 1 further comprising at least one pinion shaft extending through the differential housing transverse the rotational axis, wherein the pinion shaft is driven by a source of rotary power, wherein the pinion gears are carried on the pinion shaft and rotatable therewith, wherein the pinion gears transfer rotary power from the differential housing to the first and second side gears.

12. The differential locking device of claim 1 further comprising an anti-rotation pin coupled to the piston for preventing the piston from rotating about the first axle shaft.
